(19) United States
(12) Patent Application Publication
(10) Pub. No.: US 2009/0266948 A1
(43) Pub. Date: Oct. 29, 2009

(54) HUMAN-MACHINE INTERFACE TWO AXIS GIMBAL MECHANISM

(75) Inventors: Casey Hanlon, Queen Creek, AZ (US); Doug Smith, Phoenix, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/111,826

(22) Filed: Apr. 29, 2008

(51) Int. Cl. F16M 13/00

(52) U.S. Cl. 248/201

(57) ABSTRACT

A relatively simple, relatively small, relatively light-weight, and relatively inexpensive two-axis gimbal mechanism for a human-machine interface is provided. The gimbal assembly includes a first bracket, a second bracket, a center body, a first centering mechanism, and a second centering mechanism. The first bracket and second brackets each includes a first arm, a second arm, and a third arm. The first and second arms form substantially L-shaped sections and the third arms substantially perpendicular from the first arms. The center body is disposed between the L-shaped sections, and is rotatable from a null position about first and second rotational axes. The first and second centering mechanisms are coupled to the third arms of the first and second brackets, respectively, and are configured to supply a first centering force that urges the center body toward a null position when the center body is rotated about the rotational axes.

### TECHNICAL FIELD

The present invention generally relates to human-machine interfaces and, more particularly, to a relatively simple and inexpensive two-axis gimbal assembly for human-machine interfaces.

### BACKGROUND

Human-machine interfaces that are used to translate human movements to machine movements are used in myriad industries. For example, some aircraft flight control systems include a human-machine interface in the form of one or more control sticks. The flight control system, in response to input forces supplied to the control stick from the pilot, controls the movements of various aircraft flight control surfaces. No matter the particular end-use system, the human-machine interface preferably includes some type of haptic feedback mechanism back through the interface to the interface operator. The haptic feedback mechanism may be passive, active, or both. The interface also typically includes one or more devices, such as a gimbal assembly, for accurately converting angular displacements into rotary motion.

In many instances, the devices that are used to convert angular displacements to rotary motion are relatively complex, relatively large, relatively heavy, and relatively costly. Hence, there is a need for a device that converts angular displacements to rotary motion that is relatively simple, relatively small, relatively light-weight, and relatively inexpensive. The present invention addresses at least this need.

### BRIEF SUMMARY

In one embodiment, and by way of example only, a gimbal assembly includes a first bracket, a second bracket, a center body, a first centering mechanism, and a second centering mechanism. The first bracket includes a first arm, a second arm, and a third arm. The first and second arms of the first bracket are disposed substantially perpendicular to each other to form a first substantially L-shaped section, and the third arm of the first bracket extends substantially perpendicular from the first arm of the first bracket in a direction opposite the second arm of the first bracket. The second bracket includes a first arm, a second arm, and a third arm. The first and second arms of the second bracket are disposed substantially perpendicular to each other to form a second substantially L-shaped section, and the third arm of the second bracket extends substantially perpendicular from the first arm of the second bracket in a direction opposite the second arm of the second bracket. The center body is disposed between the first and second substantially L-shaped sections, is rotationally coupled to the first arm of the second bracket along a first rotational axis, and is rotationally coupled to the first arm of the first bracket along a second rotational axis that is perpendicular to, and co-planar with, the first rotational axis. The center body is rotatable from a null position to a plurality of control positions about the first and second rotational axes. The first centering mechanism is coupled to the third arm of the first bracket and is configured to supply a first centering force thereto that urges the center body toward the null position when the center body is rotated about the first rotational axis. The second centering mechanism is coupled to the third arm of the second bracket and is configured to supply a second centering force thereto that urges the center body toward the null position when the center body is rotated about the second rotational axis.

In another exemplary embodiment, a human-machine interface includes a first bracket, a second bracket, a center body, a user interface, a first centering mechanism, and a second centering mechanism. The first bracket includes a first arm, a second arm, and a third arm. The first and second arms of the first bracket are disposed substantially perpendicular to each other to form a first substantially L-shaped section, and the third arm of the first bracket extends substantially perpendicular from the first arm of the first bracket in a direction opposite the second arm of the first bracket. The second bracket includes a first arm, a second arm, and a third arm. The first and second arms of the second bracket are disposed substantially perpendicular to each other to form a second substantially L-shaped section, and the third arm of the second bracket extends substantially perpendicular from the first arm of the second bracket in a direction opposite the second arm of the second bracket. The center body is disposed between the first and second substantially L-shaped sections, is rotationally coupled to the first arm of the second bracket along a first rotational axis, and is rotationally coupled to the first arm of the first bracket along a second rotational axis that is perpendicular to, and co-planar with, the first rotational axis. The center body is rotatable from a null position to a plurality of control positions about the first and second rotational axes. The user interface is coupled to the center body and is configured to be grasped by a hand. The user interface extends from the center body along a third axis that, when the center body is in the null position, is perpendicular to the first and second rotational axis. The first centering mechanism is coupled to the third arm of the first bracket and is configured to supply a first centering force thereto that urges the center body toward the null position when the center body is rotated about the first rotational axis. The second centering mechanism is coupled to the third arm of the second bracket and is configured to supply a second centering force thereto that urges the center body toward the null position when the center body is rotated about the second rotational axis.

In yet another exemplary embodiment, an active human-machine interface system includes a first bracket, a second bracket, a center body, a first centering mechanism, a second centering mechanism, a first motor, a second motor, and a motor control. The first bracket includes a first arm, a second arm, and a third arm. The first and second arms of the first bracket are disposed substantially perpendicular to each other to form a first substantially L-shaped section, and the third arm of the first bracket extends substantially perpendicular from the first arm of the first bracket in a direction opposite the second arm of the first bracket. The second bracket includes a first arm, a second arm, and a third arm. The first and second arms of the second bracket are disposed substantially perpendicular to each other to form a second substantially L-shaped section, and the third arm of the second bracket extends substantially perpendicular from the first arm of the second bracket in a direction opposite the second arm of the second bracket. The center body is disposed between the first and second substantially L-shaped sections, is rotationally coupled to the first arm of the second bracket along a first rotational axis, and is rotationally coupled to the first arm of the first bracket along a second rotational axis that is perpendicular to, and co-planar with, the first rotational axis. The center body is rotatable from a null position to a plurality of control positions about the first and second rotational axes. The first centering mechanism is coupled to the third arm of the first bracket and is configured to supply a first centering force thereto that urges the center body toward the null position when the center body is rotated about the first rotational axis. The second centering mechanism is coupled to the third arm of the second bracket and is configured to supply a second centering force thereto that urges the center body toward the null position when the center body is rotated about the second rotational axis. The first motor is coupled to the second arm of the first bracket and is configured, when energized, to supply a torque to the center body about the first rotational axis. The second motor is coupled to the second arm of the second bracket and is configured, when energized, to supply a torque to the center body about the second rotational axis. The motor control is coupled to, and is operable to selectively energize, the first and second motors.

Other desirable features and characteristics of the present invention will become apparent from the following detailed description and appended claims, taken in conjunction with the accompanying drawings and preceding background.

### BRIEF DESCRIPTION OF THE DRAWINGS

The present invention will hereinafter be described in conjunction with the following drawing figures, wherein like numerals denote like elements, and

FIG. 1 is a functional block diagram of an exemplary embodiment of an active human-machine interface system; and

FIGS. 2-5 depict exemplary embodiments of a gimbal assembly that may be used to implement the system of FIG. 1.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. In this regard, although the following description is, for convenience, directed to a gimbal assembly implemented with a user interface that is configured as a control stick, it will be appreciated that the system could be implemented with variously configured user interfaces including, for example, variously configured pedals, yokes, levers, and the like. It will additionally be appreciated that the gimbal assembly may be used in any one of numerous applications, such as gyroscopes, that require two degrees of freedom.

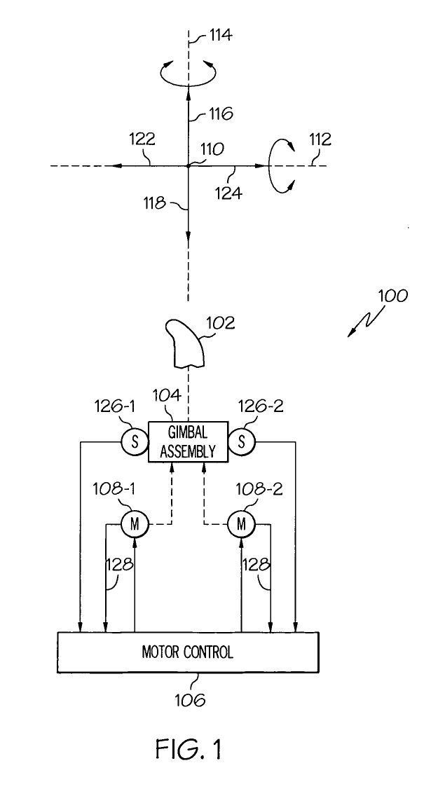

Turning now to FIG. 1, a functional block diagram of an exemplary active human-machine interface system 100 is depicted. The system 100 includes a user interface 102, a gimbal assembly 104, a motor control 106, and a plurality of motors 108 (e.g., 108-1, 108-2). The user interface 102 is coupled to the gimbal assembly 104 and is configured to move, in response to an input from a user, from a null position 110 to a plurality of control positions in a plurality of movement directions.

The gimbal assembly 104 is configured to rotate about two perpendicular and co-planar rotational axes—a first rotational axis 112 and a second rotational axis 114. Thus, if a user moves the user interface in a forward direction 116 or an aft direction 118, the gimbal assembly 104 rotates about the first rotational axis 112. Similarly, if a user moves the user interface in a left direction 122 or a right direction 124, the gimbal assembly 104 rotates about the second rotational axis 114. It will additionally be appreciated that gimbal assembly 104 is configured to allow the user interface 102 to be moved in a combined forward-left direction, a combined forward-right direction, a combined aft-left direction, or a combined aft-right direction, and back to or through the null position 110.

Movement of the user interface 102 is sensed via a plurality of user interface sensors 126 (e.g., 126-1, 126-2). The user interface sensors 126 are coupled to the user interface 102, the gimbal assembly 104, or both, and supply user interface movement signals. The user interface sensors 126 may be variously implemented, but are preferably implemented using any one of numerous known force sensors, position sensors, or both. Some suitable force sensors include, but are not limited to, strain gage sensors, piezoelectric sensors, semiconductor sensors, or optical sensors, just to name a few, and suitable position sensors include, but are not limited to, absolute inceptor position sensors such as RVDTs, LVDTs, potentiometers, or optical sensors. No matter the specific number and type of user interface sensors 126, at least one of the sensors 126 is configured to supply user interface movement signals representative of a vector component of user interface movement along the first rotational axis 112, and another sensor 126 is configured to supply user interface movement signals representative of a vector component of user interface movement along the second rotational axis 114. Depending on the type of sensors, it will be appreciated that the user interface movement signals may be force signals, position signals, or both. In any case, the user interface movement signals are supplied to the motor control 106.

The motor control 106, upon receipt of the user interface movement signals, selectively energizes one of the motors 108-1, 108-2. The motors 108 are each operable, upon being appropriately energized, to generate torque and supply haptic feedback to the user interface 102. Preferably, the motors 108 are each implemented using multi-phase brushless DC machines. As such, current feedback and commutation signals 128 associated with each motor 108 are supplied to the motor control 106. It will be appreciated that although the motor control 106 is depicted using a single functional block, its described functionality could be implemented using two individual motor controls, one associated with each motor 108.

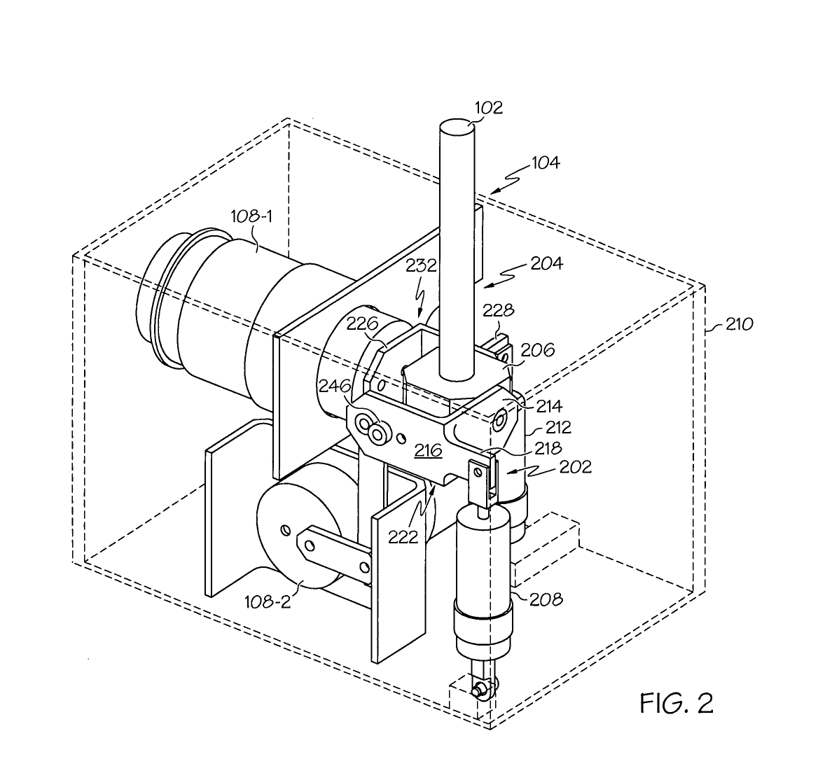

Turning now to FIGS. 2-5, a more detailed description of a particular preferred embodiment of the gimbal assembly 104 will be provided. With reference first to FIG. 2, it is seen that the gimbal assembly 104 includes a first bracket 202, a second bracket 204, a center body 206, a first centering mechanism 208, and a second centering mechanism 212, all disposed within a housing 210 (depicted in phantom in FIG. 2). The first bracket 202 includes a first arm 214, a second arm 216, and a third arm 218. The first and second arms 214, 216 of the first bracket 202 are disposed substantially perpendicular to each other to form a first substantially L-shaped section 222. The third arm 218 of the first bracket 202 extends substantially perpendicular from the first arm 214 of the first bracket 202 in a direction opposite the second arm 216 of the first bracket 202.

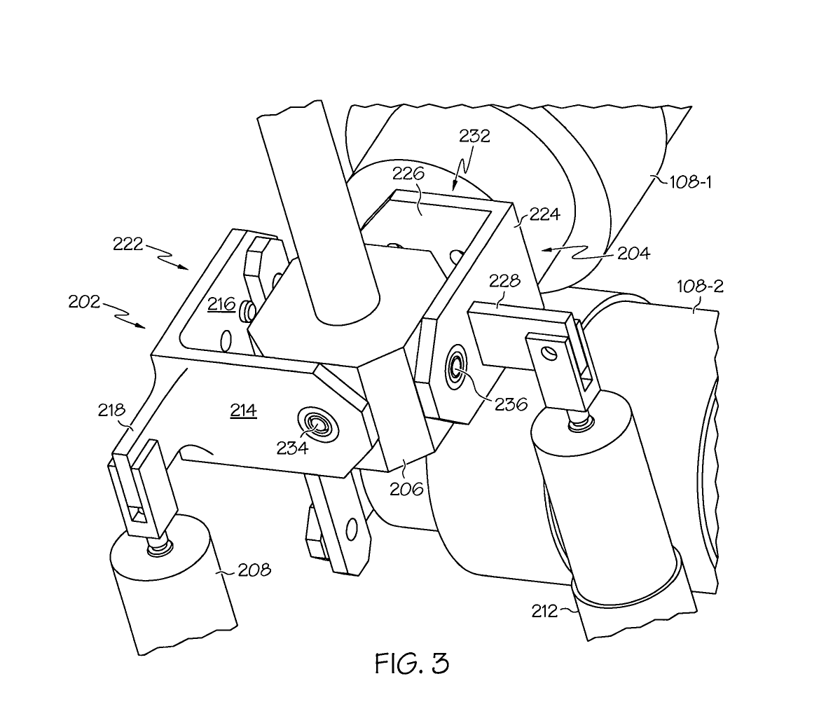

The second bracket 204 is similar to the first bracket 202 in that it includes a first arm 224, a second arm 226, and a third arm 228. Also like the first bracket 202, the first and second arms 226, 228 of the second bracket 204 are disposed substantially perpendicular to each other to form a second substantially L-shaped section 232. Additionally, the third arm 228 of the second bracket 204 extends substantially perpendicular from the first arm 224 of the second bracket 204 in a direction opposite the second arm 226 of the second bracket 204. However, as depicted most clearly in FIG. 3, the third arm 218 of the first bracket 204 and the third arm 228 of the second bracket 204 extend from different locations on the first arms 214, 224 of the first 202 and second 206 brackets, respectively. It will be appreciated that this configuration is merely exemplary, and that the third arms 218, 228 of the first 202 and second 204 brackets 204 could extend from the same locations on the first arms 214, 224 of the first 202 and second 206 brackets, respectively.

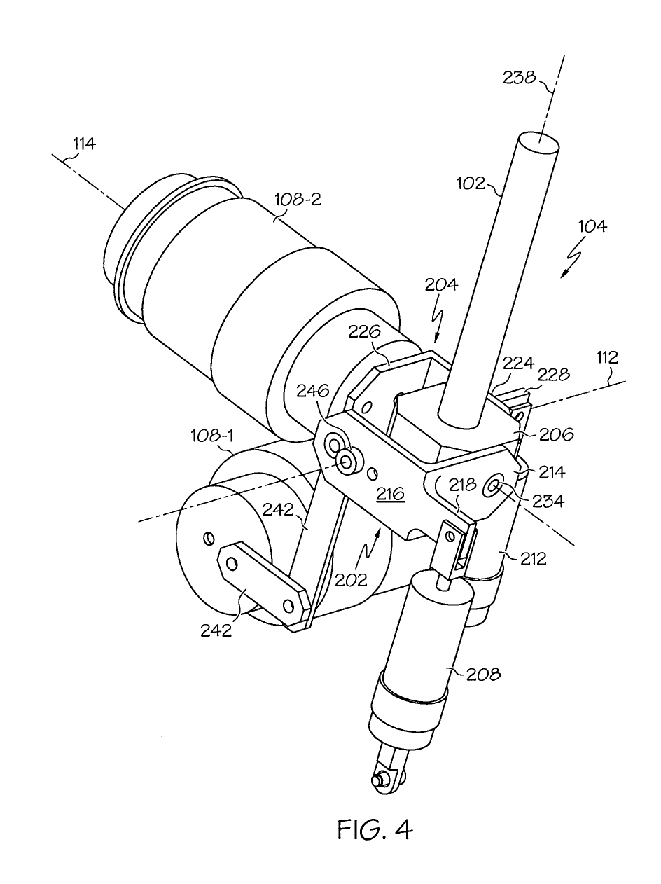

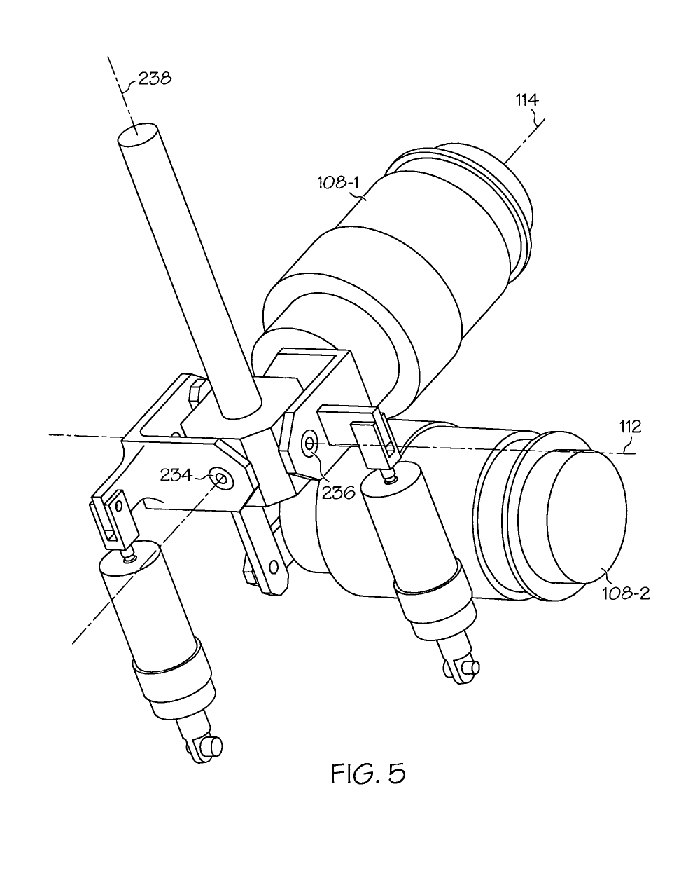

The center body 206 is disposed between the first and second substantially L-shaped sections 222, 232, and is rotationally coupled to the first arms 214, 224 of the first and second brackets 202, 204. Specifically, and as shown most clearly in FIGS. 4 and 5, the center body 206 is rotationally coupled, via a first bearing assembly 234, to the first arm 214 of the first bracket 202 along the second rotational axis 114, and is rotationally coupled, via a second bearing assembly 236, to the first arm 224 of the second bracket 204 along the first rotational axis 112. The center body 206 is thus rotatable from the null position 110 to a plurality of control positions about the first and second rotational axes 112, 114. The center body 206 is also coupled to the user interface 102, which extends from the center body 206 along a third axis 238 that, when the center body 206 is in the null position 110, is perpendicular to the first and second rotational axes 112, 114.

The center body 206, and thus the user interface 102, is passively urged toward the null position 110 via the first 208 and second 212 centering mechanisms. In particular, the first centering mechanism 208 is coupled to the third arm 218 of the first bracket 202 and is configured to supply a first centering force thereto that urges the center body 206 toward the null position 110 when the center body 206 is rotated about the first rotational axis 112. The second centering mechanism 212 is coupled to the third arm 228 of the second bracket 204 and is configured to supply a second centering force thereto that urges the center body 206 toward the null position 110 when the center body 206 is rotated about the second rotational axis 114. It will be appreciated that the first and second centering mechanisms 208, 212 could be variously implemented. In the preferred embodiment, however, the mechanisms are implemented using springs.

As noted above when describing FIG. 1, the first and second motors 108-1, 108-2 may supply haptic feedback to the user interface 102. To do so, and with continued reference to FIGS. 4 and 5, it is seen that the first motor 108-1 is coupled to the second arm 216 of the first bracket 202, and the second motor 108-2 is coupled to the second arm 226 of the second bracket 204. Thus, when the motor control 106 causes the first motor 108-1 to be energized, the first motor 108-1 supplies a torque to the center body 206 about the first rotational axis 112. Similarly, when the motor control 106 causes the second motor 108-2 to be energized, the second motor 108-2 supplies a torque to the center body 206 about the second rotational axis 112. In the depicted embodiment, it is seen that the first motor 108-1 is disposed remote from the first rotational axis 112, whereas the second motor 108-2 is disposed along the second rotational axis 114. As such, the first motor 108-1 is coupled to the second arm 216 of the first bracket 202 via a plurality of links 238, 242. It will be appreciated that this configuration is merely exemplary of a particular preferred embodiment, and that the first and second motors 108-1, 108-2 could be alternatively arranged.

Returning once again to FIG. 2, it may be seen that the first bracket 202 and the second bracket 204 are mounted within the housing 210 in a manner that each is rotatable relative to the housing 210. Specifically, the first bracket 202 is rotatable relative to the housing 210 about the first rotational axis 112, and the second bracket 204 is rotatable relative to the housing 210 about the second rotational axis 114. Although the specific mounting configuration may vary, in the depicted embodiment the first bracket 202 is rotationally coupled to the housing 210 via a suitable bearing assembly 246. The second bracket 204, however, is coupled to the second motor 108-2, which is fixed relative to the housing 210.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A gimbal assembly, comprising:
a first bracket including a first arm, a second arm, and a third arm, the first and second arms of the first bracket disposed substantially perpendicular to each other to form a first substantially L-shaped section, the third arm of the first bracket extending substantially perpendicular from the first arm of the first bracket in a direction opposite the second arm of the first bracket;
a second bracket including a first arm, a second arm, and a third arm, the first and second arms of the second bracket disposed substantially perpendicular to each other to form a second substantially L-shaped section, the third arm of the second bracket extending substantially perpendicular from the first arm of the second bracket in a direction opposite the second arm of the second bracket;
a center body disposed between the first and second substantially L-shaped sections, the center body rotationally coupled to the first arm of the first bracket along a first rotational axis and rotationally coupled to the first arm of the second bracket along a second rotational axis that is perpendicular to, and co-planar with, the first rotational axis, the center body rotatable from a null position to a plurality of control positions about the first and second rotational axes;
a first centering mechanism coupled to the third arm of the first bracket and configured to supply a first centering force thereto that urges the center body toward the null position when the center body is rotated about the second rotational axis; and
a second centering mechanism coupled to the third arm of the second bracket and configured to supply a second centering force thereto that urges the center body toward the null position when the center body is rotated about the first rotational axis.

2. The assembly of claim 1, further comprising:
a first motor coupled to the second arm of the first bracket and configured, when energized, to supply a torque to the center body about the first rotational axis; and
a second motor coupled to the second arm of the second bracket and configured, when energized, to supply a torque to the center body about the second rotational axis.

3. The assembly of claim 2, wherein:
one of the first motor and the second motor is disposed remote from the first rotational axis; and
one of the second motor and the first motor is disposed along the second rotational axis.

4. The assembly of claim 3, further comprising:
a plurality of links coupled between the remotely disposed motor and the second arm of one or the first bracket and the second bracket.

5. The assembly of claim 1, further comprising:
a user interface coupled to, and extending from, the center body, the user interface configured to be grasped by a hand.

6. The assembly of claim 1, further comprising:
a housing coupled to the first bracket, the second bracket, the first centering mechanism, and the second centering mechanism.

7. The assembly of claim 6, wherein:
the first bracket is rotatable relative to the housing about the second rotational axis; and
the second bracket is rotatable relative to the housing about the first rotational axis.

8. The assembly of claim 6, wherein:
the first centering mechanism is coupled between the housing and the third arm of the first bracket; and
the second centering mechanism is coupled between the housing and the third arm of the second bracket.

9. A human-machine interface, comprising:
a first bracket including a first arm, a second arm, and a third arm, the first and second arms of the first bracket disposed substantially perpendicular to each other to form a first substantially L-shaped section, the third arm of the first bracket extending substantially perpendicular from the first arm of the first bracket in a direction opposite the second arm of the first bracket;
a second bracket including a first arm, a second arm, and a third arm, the first and second arms of the second bracket disposed substantially perpendicular to each other to form a second substantially L-shaped section, the third arm of the second bracket extending substantially perpendicular from the first arm of the second bracket in a direction opposite the second arm of the second bracket;
a center body disposed between the first and second substantially L-shaped sections, the center body rotationally coupled to the first arm of the first bracket along a first rotational axis and rotationally coupled to the first arm of the second bracket along a second rotational axis that is perpendicular to, and co-planar with, the first rotational axis, the center body rotatable from a null position to a plurality of control positions about the first and second rotational axes;
a user interface coupled to the center body and configured to be grasped by a hand, the user interface extending from the center body along a third axis that, when the center body is in the null position, is perpendicular to the first and second rotational axes;
a first centering mechanism coupled to the third arm of the first bracket and configured to supply a first centering force thereto that urges the center body toward the null position when the center body is rotated about the first rotational axis; and
a second centering mechanism coupled to the third arm of the second bracket and configured to supply a second centering force thereto that urges the center body toward the null position when the center body is rotated about the second rotational axis.

10. The assembly of claim 9, further comprising:
a first motor coupled to the second arm of the first bracket and configured, when energized, to supply a torque to the center body about the first rotational axis; and
a second motor coupled to the second arm of the second bracket and configured, when energized, to supply a torque to the center body about the second rotational axis.

11. The assembly of claim 10, wherein:
one of the first motor and the second motor is disposed remote from the first rotational axis; and
one of the second motor and the first motor is disposed along the second rotational axis.

12. The assembly of claim 11, further comprising:
a plurality of links coupled between the remotely disposed motor and the second arm of one of the first bracket and the second bracket.

13. An active human-machine interface system, comprising:
a first bracket including a first arm, a second arm, and a third arm, the first and second arms of the first bracket disposed substantially perpendicular to each other to form a first substantially L-shaped section, the third arm of the first bracket extending substantially perpendicular from the first arm of the first bracket in a direction opposite the second arm of the first bracket;
a second bracket including a first arm, a second arm, and a third arm, the first and second arms of the second bracket disposed substantially perpendicular to each other to form a second substantially L-shaped section, the third arm of the second bracket extending substantially perpendicular from the first arm of the second bracket in a direction opposite the second arm of the second bracket;
a center body disposed between the first and second substantially L-shaped sections, the center body rotationally coupled to the first arm of the first bracket along a first rotational axis and rotationally coupled to the first arm of the second bracket along a second rotational axis that is perpendicular to, and co-planar with, the first rotational axis, the center body rotatable from a null position to a plurality of control positions about the first and second rotational axes;
a first centering mechanism coupled to the third arm of the first bracket and configured to supply a first centering force thereto that urges the center body toward the null position when the center body is rotated about the first rotational axis;
a second centering mechanism coupled to the third arm of the second bracket and configured to supply a second centering force thereto that urges the center body toward the null position when the center body is rotated about the second rotational axis;
a first motor coupled to the second arm of the first bracket and configured, when energized, to supply a torque to the center body about the first rotational axis;
a second motor coupled to the second arm of the second bracket and configured, when energized, to supply a torque to the center body about the second rotational axis; and
a motor control coupled to, and operable to selectively energize, the first and second motors.

14. The assembly of claim 13, wherein:
one of the first motor and the second motor is disposed remote from the first rotational axis; and
one of the second motor and the first motor is disposed along the second rotational axis.

15. The assembly of claim 14, further comprising:
a plurality of links coupled between the remotely disposed motor and the second arm of one of the first bracket and the second bracket.

16. The assembly of claim 1, further comprising:
a user interface coupled to, and extending from, the center body, the user interface configured to be grasped by a hand.

17. The assembly of claim 13, further comprising:
a housing coupled to the first bracket, the second bracket, the first centering mechanism, and the second centering mechanism.

18. The assembly of claim 17, wherein:
the first bracket is rotatable relative to the housing about the first rotational axis; and
the second bracket is rotatable relative to the housing about the second rotational axis.

19. The assembly of claim 18, wherein:
the first centering mechanism is coupled between the housing and the third arm of the first bracket; and
the second centering mechanism is coupled between the housing and the third arm of the second bracket.
